(19) United States
(12) Patent Application Publication
(10) Pub. No.: US 2026/0122435 A1
(43) Pub. Date: Apr. 30, 2026

(54) SCALABLE AUDIO CAPTURE ON ELECTRONIC DEVICES

(71) Applicant: Netflix, Inc., Los Gatos, CA (US)

(72) Inventors: Frederic Turmel, Sunnyvale, CA (US); Alvaro Prieto, Sunnyvale, CA (US)

(21) Appl. No.: 19/373,369

(22) Filed: Oct. 29, 2025

Related U.S. Application Data
(60) Provisional application No. 63/714,689, filed on Oct. 31, 2024.

(51) Int. Cl. H04R 29/00; H04R 1/08; H04R 9/02

(52) U.S. Cl. CPC H04R 29/003; H04R 1/083; H04R 9/025; H04R 2410/05; H04R 2420/01; H04R 2499/11; H04R 2499/15

(57) ABSTRACT

Audio capture apparatuses may include a magnetic detector positioned adjacent to an audio speaker to sense variations in the magnetic field generated by the speaker’s electromagnetic coil, and a signal-conditioning module including a pre-amplifier and a noise-profile module. The noise-profile module may record a reference magnetic signal representing background electromagnetic noise and may subtract that reference magnetic signal during audio capture to isolate the true audio signal. Systems including such audio capture apparatuses may support simultaneous testing of multiple electronic devices within shared environments without acoustic crosstalk, thereby enabling scalable and interference-resistant testing. Various other apparatuses, systems, and methods are also disclosed.

### CROSS REFERENCE TO RELATED APPLICATION

This application claims the benefit of U.S. Provisional Patent Application Serial No. 63/714,689, filed 31 October 2024, the entire contents of which are incorporated herein by reference.

### BACKGROUND

Many electronics manufacturers and/or digital content providers now require large-scale automated testing of audio and video performance. In such testing environments, audio capture is typically performed using air-coupled microphones or contact transducers to record sound output from device speakers. Because multiple devices often operate simultaneously in a common testing environment (e.g., in a common space or room), acoustic interference and ambient noise can degrade microphone-based measurements.

Conventional approaches often rely on isolating each device in dedicated soundproof enclosures; however, this requirement increases lab footprint and can necessitate specialized cooling for heat dissipation. Moreover, alternative methods such as direct line-out connections or optical taps may address certain acoustic challenges but introduce additional wiring complexity and may not reflect actual speaker output conditions. Existing solutions also struggle to distinguish speaker-generated signals from background noise, such as noise produced by nearby electronic components.

The present disclosure identifies and addresses a need for audio testing techniques that can scale to numerous devices in a shared environment while maintaining reliable and interference-resistant audio capture.

### SUMMARY

As will be described in greater detail below, the present disclosure describes apparatuses, methods, and systems for audio capture and testing on electronic devices that include an audio speaker.

In some aspects, an audio capture apparatus includes a magnetic detector configured to be positioned adjacent to an audio speaker of an electronic device and to sense variations of a magnetic field generated by an electromagnetic coil of the audio speaker. In some examples, a signal-conditioning module of the apparatus includes a pre-amplifier operatively coupled to the magnetic detector and configured to output an electrical audio signal corresponding to the sensed variations and a noise-profile module that is configured to record, while the audio speaker is not emitting audio, a reference magnetic signal representative of background electromagnetic noise produced by non-speaker components of the electronic device and, during subsequent audio capture, subtract the reference magnetic signal from the electrical audio signal to obtain a filtered test audio signal.

In some examples, the noise-profile module is configured to complete recording of the reference magnetic signal in less than one minute. In some examples, the magnetic detector is mechanically coupled to a printed circuit board that carries the pre-amplifier. In some examples, the signal-conditioning module further includes a frequency-equalization filter configured to attenuate over-amplification at resonant frequencies of the magnetic detector to provide a substantially flat frequency response across an audible range. In some examples, the frequency-equalization filter includes a digital filter having coefficients selected in accordance with measured resonant characteristics of the magnetic detector. In some examples, the magnetic detector includes a magnetic pickup microphone. In some examples, the signal-conditioning module further includes a user-feedback interface configured to display a real-time indication of a magnitude of the electrical audio signal to guide placement of the magnetic detector relative to the audio speaker. In some examples, the magnetic detector is one of a plurality of magnetic detectors each configured to be associated with a different electronic device and to operate concurrently within a common test environment without acoustic crosstalk between the electronic devices. In some examples, the plurality of magnetic detectors are coupled to a common controller configured to record audio signals from all of the plurality of magnetic detectors simultaneously on separate channels.

In some aspects, a system of the present disclosure includes a plurality of magnetic pickup assemblies for respectively testing audio signals of a plurality of electronic devices. Each magnetic pickup assembly includes: a magnetic detector configured to be positioned adjacent to an audio speaker of a respective electronic device in a shared test environment to sense variations in a magnetic field generated by an electromagnetic coil of the audio speaker; and a signal-conditioning module operatively coupled to each magnetic detector and configured to convert sensed magnetic field variations into a corresponding conditioned electrical audio signal. The system also includes a controller coupled to each signal-conditioning module and configured to: concurrently receive and record the conditioned electrical audio signals from the plurality of magnetic pickup assemblies on separate channels; capture, prior to audio playback, for each respective electronic device, a reference magnetic noise profile representative of background electromagnetic noise; and subtract the reference magnetic noise profile from each subsequent conditioned electrical audio signal to provide interference-resistant audio capture without acoustic crosstalk among the plurality of electronic devices.

In some examples, the controller is configured to complete capture of the reference magnetic noise profile for each respective electronic device in less than one minute. In some examples, each signal-conditioning module includes a pre-amplifier operatively coupled to the magnetic detector. In some examples, each signal-conditioning module further includes a frequency-equalization filter configured to attenuate over-amplification at resonant frequencies of the magnetic detector. In some examples, each magnetic detector includes a magnetic pickup microphone. In some examples, each electronic device of the plurality of electronic devices is selected from the group consisting of: smartphones; digital televisions; computer monitors; tablets; and soundbars.

In some examples, a method for capturing an audio signal of the present disclosure includes obtaining a baseline magnetic noise signal with a magnetic detector. In these examples, a test audio signal is generated for playback on an audio speaker of an electronic device. A test magnetic signal is then measured with the magnetic detector during the playback on the audio speaker, where the magnetic detector senses variations of a magnetic field generated by an electromagnetic coil of the audio speaker. The baseline magnetic noise signal is then subtracted from the measured test magnetic signal to obtain a filtered test audio signal.

In some examples, the method further includes filtering out a resonant frequency of the magnetic detector from the measured test magnetic signal to obtain the filtered test audio signal. In examples, obtaining the baseline magnetic noise signal includes recording the baseline magnetic noise signal for a duration of less than one minute while the audio speaker is not emitting audio. In some examples, the method further includes identifying a resonant frequency of the magnetic detector and attenuating over-amplification of the measured test magnetic signal at the resonant frequency of the magnetic detector. In some examples, the method further includes displaying, via a user-feedback interface, a real-time indication of a magnitude of the measured test magnetic signal to guide placement of the magnetic detector relative to the audio speaker.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of a system for audio capture from electronic devices, according to at least one embodiment of the present disclosure.

FIG. 2 is a diagram of an audio capture apparatus configured to capture audio from an audio speaker in a television or similar device, according to at least one embodiment of the present disclosure.

FIG. 3 is a diagram of an audio capture apparatus configured to capture audio from an audio speaker in a smartphone or similar device, according to at least one embodiment of the present disclosure.

FIG. 4 is a diagram of a test environment and system including multiple audio capture apparatuses for capturing audio from multiple respective electronic devices, according to at least one embodiment of the present disclosure.

FIG. 5 is a block diagram of an audio capture apparatus, according to at least one embodiment of the present disclosure.

FIG. 6 is a flow diagram illustrating a method for capturing an audio signal from electronic devices, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides illustrative embodiments of systems, methods, and apparatuses related to scalable audio capture on electronic devices, such as smart TVs, smartphones, and other electronic devices equipped with audio speakers. The disclosed technology is generally directed to improving the reliability and scalability of audio testing in environments where multiple devices operate simultaneously, addressing challenges such as acoustic interference, ambient noise, and electromagnetic interference. By leveraging the electromagnetic properties of speaker systems, the disclosed approach enables interference-resistant audio capture without the need for soundproof enclosures or complex wiring or cooling setups, thereby facilitating large-scale automated testing in shared environments.

The testing of audio and video performance in electronic devices, such as smart TVs and smartphones, presents significant challenges, particularly in environments requiring large-scale automated testing. Conventional methods for audio capture rely on air-coupled microphones or contact transducers to record sound output from device speakers. However, these approaches are highly susceptible to acoustic interference and ambient noise, especially when multiple devices operate simultaneously in shared lab spaces. To mitigate such interference, traditional solutions often involve isolating each device in soundproof enclosures. While effective in reducing noise, this approach increases the lab’s physical footprint and necessitates additional cooling systems to manage heat dissipation. Alternative methods, such as direct line-out connections or optical taps, address some acoustic challenges but introduce wiring complexity and fail to replicate the actual conditions of speaker output. Furthermore, existing solutions struggle to distinguish speaker-generated signals from background noise emitted by nearby electronic components, leading to unreliable test results.

The disclosed system addresses these limitations by introducing a novel method for scalable audio capture that leverages the electromagnetic properties of speaker systems. Instead of relying on traditional microphones to capture sound waves traveling through the air or via contact transducers, the disclosed system utilizes magnetic pickups to measure variations in a magnetic field generated by the speaker’s electromagnetic coil. These magnetic pickups, which may be adapted from guitar pickup technology, are equipped with custom boards and onboard amplifiers to ensure optimal signal levels. By capturing the magnetic field directly at the source, the system resists acoustic interference and ambient noise, enabling reliable audio capture even in noisy, shared environments. This approach eliminates the need for soundproof enclosures and reduces the complexity of wiring, while also providing a more accurate representation of the speaker’s output.

The disclosed system further incorporates advanced noise mitigation techniques to address potential electromagnetic interference from other device components. A noise profile is captured for each device prior to audio testing, setting a baseline signal and allowing the system to digitally filter out unwanted noise during actual measurements. Additionally, the magnetic pickups are designed for a flat response across the audible spectrum, minimizing issues related to resonant frequencies. In some examples, the system integrates seamlessly with existing testing frameworks, such as the "eye patch" system (e.g., as described in U.S. Patent No. 10,306,270, the entire disclosure of which is incorporated herein by reference), to synchronize audio and video testing, enabling precise analysis of audio-video synchronization and playback quality. This scalable and interference-resistant solution not only enhances the reliability of audio testing but also expands the approach to devices like smartphones, where traditional methods have proven inadequate. By addressing the limitations of prior approaches, the described framework provides a robust and efficient method for large-scale audio testing of electronic devices in diverse environments.

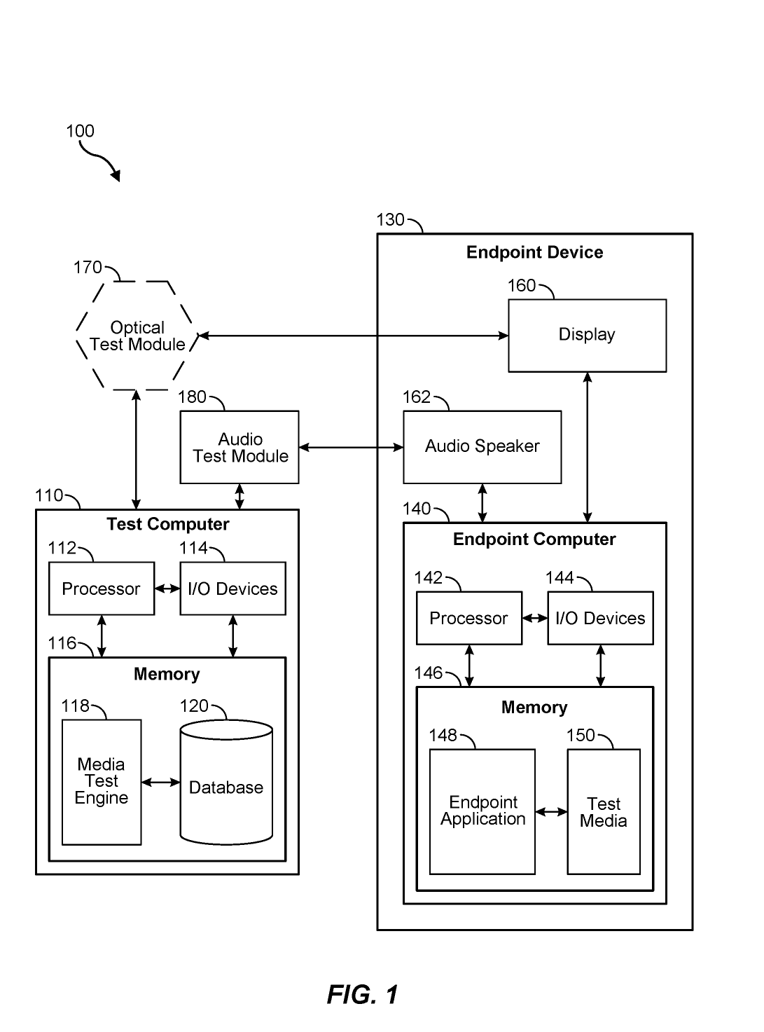

FIG. 1 is a block diagram of a system 100 for audio capture from electronic devices, according to at least one embodiment of the present disclosure.

System 100 can serve as an audio performance testing framework for electronic devices. In this example, system 100 includes a test computer 110, an endpoint device 130 (e.g., an electronic device), an endpoint computer 140 (which may be part of endpoint device 130), and an audio test module 180. Optionally, in some examples, system 100 can also include an optical test module 170, which could be separate from audio test module 180 or in a combined assembly. The components of system 100 can cooperate to generate test media 150 for playback on endpoint device 130, execute tests while test media 150 is being played, capture output, and analyze results.

Test computer 110 can operate as a central control unit for running the tests and analyzing results. Test computer 110 can include a processor 112, I/O devices 114, memory 116, a media test engine 118, and a database 120. For example, processor 112 can execute computer-readable instructions to generate test signals and coordinate data flow among the components. In this example, I/O devices 114 of test computer 110 can facilitate communication with endpoint device 130, optical test module 170 (if present), and/or audio test module 180 via interfaces such as USB, Ethernet, HDMI, and/or wireless protocols. Furthermore, memory 116 of test computer 110 can store the media test engine 118 and database 120. Database 120 can maintain structured storage of test data, configurations, and results to enable repeatable and scalable testing processes.

In some embodiments, media test engine 118 performs generation and analysis of test media. For example, media test engine 118 can be a software module stored in memory 116 and executed by processor 112. For example, media test engine 118 can include algorithms for noise filtering, synchronization analysis, and/or quality assessment of audio and video output. As a result, media test engine 118 can provide feedback on the performance of endpoint device 130 by analyzing captured data from optical test module 170 and/or audio test module 180.

In some examples, endpoint device 130 represents an electronic device under test. For example, endpoint device 130 may be a device that includes one or more audio speakers 162, such as a television (e.g., a smart TV), a smartphone, a tablet, a personal computer, a digital monitor, and/or a soundbar. Any of these devices can be evaluated for audio performance alone or in a shared testing environment where multiple endpoint devices 130 operate simultaneously. In some examples, endpoint device 130 includes a display 160 for presenting visual content. In some embodiments, optical test module 170 is configured to test an output of display 160 separately from and/or simultaneously with audio test module 180 testing audio speaker 162. When optical test module 170 and audio test module 180 are used simultaneously, synchronization between visual content and audio content output by endpoint device 130 can be tested and analyzed by test computer 110.

Endpoint computer 140 can operate as a player and/or controller and may be embedded within endpoint device 130 or may be separate from and in communication with endpoint device 130. In some embodiments, endpoint computer 140 may operate as part of or in communication with endpoint device 130 to process and play test media via display 160 and/or audio speaker 162. In some embodiments, endpoint computer 140 can include a processor 142, I/O devices 144, memory 146, an endpoint application 148, and test media 150. For example, processor 142 can execute instructions within endpoint application 148 to control playback of test media 150, and I/O devices 144 can provide interfaces to display 160 and/or audio speaker 162. Additionally, memory 146 can store test media 150 and endpoint application 148, where test media 150 can include audio and/or video content used during evaluation.

System 100 can perform external evaluation of audio and visual performance of endpoint device 130 using optical test module 170 and audio test module 180 in a variety of ways. In some embodiments, optical test module 170 can capture video output from display 160 and provide image data to test computer 110 for analysis. Similarly, audio test module 180 can capture sound output from audio speaker 162 and provide audio data to test computer 110. Accordingly, optical test module 170 and audio test module 180 can enable system 100 to verify synchronization, quality, and performance metrics of endpoint device 130 under test.

As explained further below, audio test module 180 can include a magnetic detector designed to sense and measure variations in a magnetic field. In the context of evaluation of audio performance, the magnetic detector can be used to detect a magnetic field and/or changes in a magnetic field generated by an electromagnetic coil of audio speaker 162 under test. Variations in the magnetic field are converted into electrical signals that correspond to the audio output. This allows for precise and interference-resistant audio capture by directly measuring the magnetic properties of the speaker system.

Magnetic fields generated by a source, such as the electromagnetic coil of audio speaker 162, generally decrease in strength as the distance from the source increases. More specifically, magnetic field strength decreases proportionally to an inverse of the cube of a distance from the source. As a result, the intensity of the magnetic field diminishes rapidly with increasing distance, which naturally reduces the influence of external magnetic interference from nearby electronic components or other devices. This property may be beneficial in environments where multiple devices operate simultaneously, as it enables precise and localized detection of the magnetic field generated by a specific source, such as an audio speaker, while effectively filtering out unwanted noise or interference from other sources. This feature is utilized in the disclosed system 100 to promote reliable and interference-resistant audio capture, such as in shared testing environments.

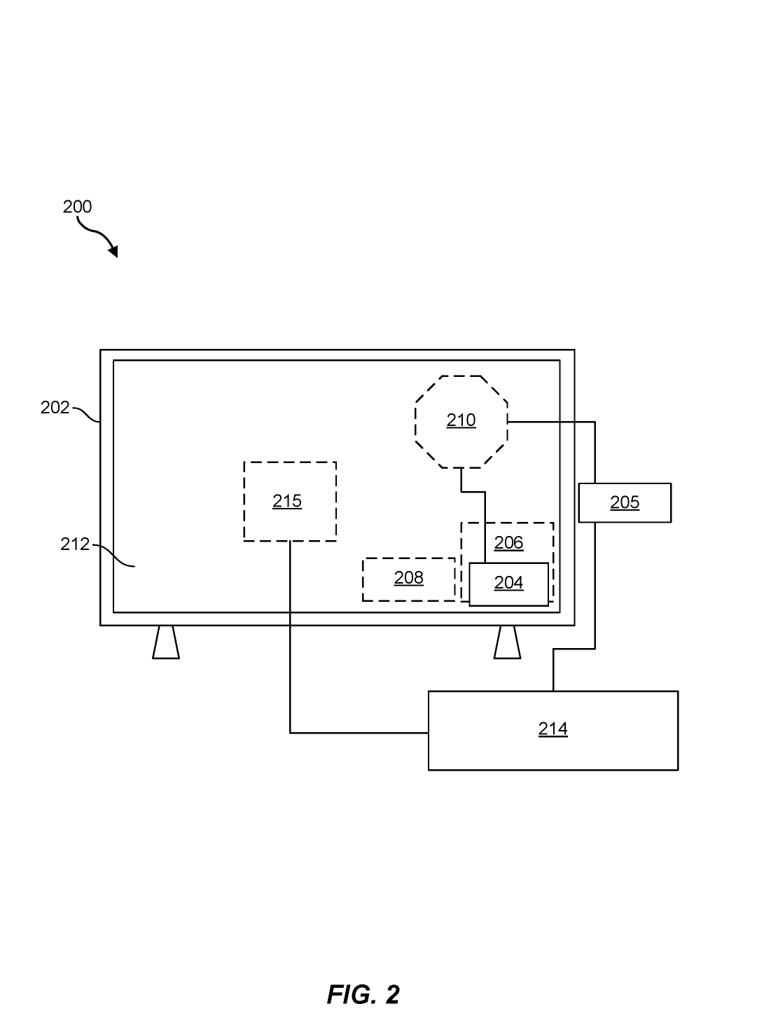

FIG. 2 is a diagram of an audio capture apparatus 200 configured to capture audio from an audio speaker 206 in a television 202, according to at least one embodiment of the present disclosure.

Audio capture apparatus 200 of FIG. 2 includes a magnetic detector 204, which is positioned adjacent to an audio speaker 206 of a television 202 for testing. Magnetic detector 204 is configured to sense variations in a magnetic field generated by an electromagnetic coil (e.g., a voice coil) of speaker 206. These variations are converted into electrical signals by a signal-conditioning module 205, which can include a pre-amplifier to optimize signal levels and a noise-profile module to filter out background electromagnetic noise.

The noise-profile module of signal-conditioning module 205 is configured to reduce noise from nearby electromagnetic components, such as another electromagnetic component 208 (e.g., a display controller, another audio speaker, etc.) of television 202, which may emit interfering magnetic fields. Before audio capture of audio speaker 206 begins, the noise-profile module records, through magnetic detector 204, a reference magnetic signal while audio speaker 206 remains inactive, capturing the baseline electromagnetic noise generated by non-speaker components, including other electromagnetic component 208. During subsequent audio capture by magnetic detector 204, the noise-profile module subtracts this reference magnetic signal from the detected magnetic field variations, thereby isolating a signal generated by the electromagnetic coil of audio speaker 206. Furthermore, the magnetic detector 204 can be configured to be highly sensitive and directional, enabling it to concentrate on the localized magnetic field of the speaker while reducing the impact of external magnetic interference. This combination of noise profiling and directional sensitivity can facilitate reliable and interference-resistant audio capture, even in environments with multiple electronic components emitting magnetic fields.

In some examples, magnetic detector 204 optionally works in conjunction with an optical test module 210, which can be employed to test a visual signal of a display screen 212 of television 202. A test computer 214 can be operatively coupled to magnetic detector 204, signal-conditioning module 205, and optical test module 210 (if present). Test computer 214 functions as a central control unit within the audio capture system, managing the testing and analysis of audio and video performance for one or more electronic devices.

As discussed above with reference to FIG. 1, test computer 214 can include a processor, memory, input/output (I/O) devices, and a media test engine, which work together to support the generation, execution, and analysis of test media. The processor of test computer 214 executes computer-readable instructions to regulate data flow between connected components, such as optical test module 210 (if present) and magnetic detector 204. The memory of test computer 214 retains the media test engine and a database containing structured test data, configurations, and results. The media test engine incorporates algorithms for noise filtering, synchronization analysis, and quality assessment, enabling accurate evaluation of audio and/or video outputs. Test computer 214 further supports communication with endpoint devices and testing modules through various interfaces, including USB, Ethernet, HDMI, and/or wireless protocols, allowing for efficient integration and adaptable testing across one or more devices, such as in shared environments.

Audio capture apparatus 200 of FIG. 2 is illustrated with signal-conditioning module 205 as a separate component from magnetic detector 204, optical test module 210, and test computer 214. However, the present disclosure is not so limited. For example, signal-conditioning module 205 can be integrated with magnetic detector 204 (e.g., on a common printed circuit board as magnetic detector 204), with optical test module 210, and/or with test computer 214.

In some examples, audio capture apparatus 200 can be further equipped with a user-feedback interface 215 that provides real-time guidance for improved placement of magnetic detector 204 relative to audio speaker 206. User-feedback interface 215 can be configured to provide real-time visual and/or auditory cues to guide the user in positioning magnetic detector 204 at an ideal distance from, position relative to, and orientation relative to audio speaker 206. For example, by playing a calibration tone through audio speaker 206, user-feedback interface 215 measures the signal strength and dynamic range of the magnetic field variations detected by magnetic detector 204. User-feedback interface 215 then displays feedback (e.g., on display screen 212 of television 202 as illustrated in FIG. 2, or on another, separate display), such as a graphical indicator or color-coded signal strength, to inform the user whether the detector is positioned correctly or requires adjustment. This feature may reduce risk of signal saturation and/or attenuation caused by improper placement, thereby enhancing reliability and accuracy of the audio capture process. Accordingly, user-feedback interface 215 can simplify the setup process.

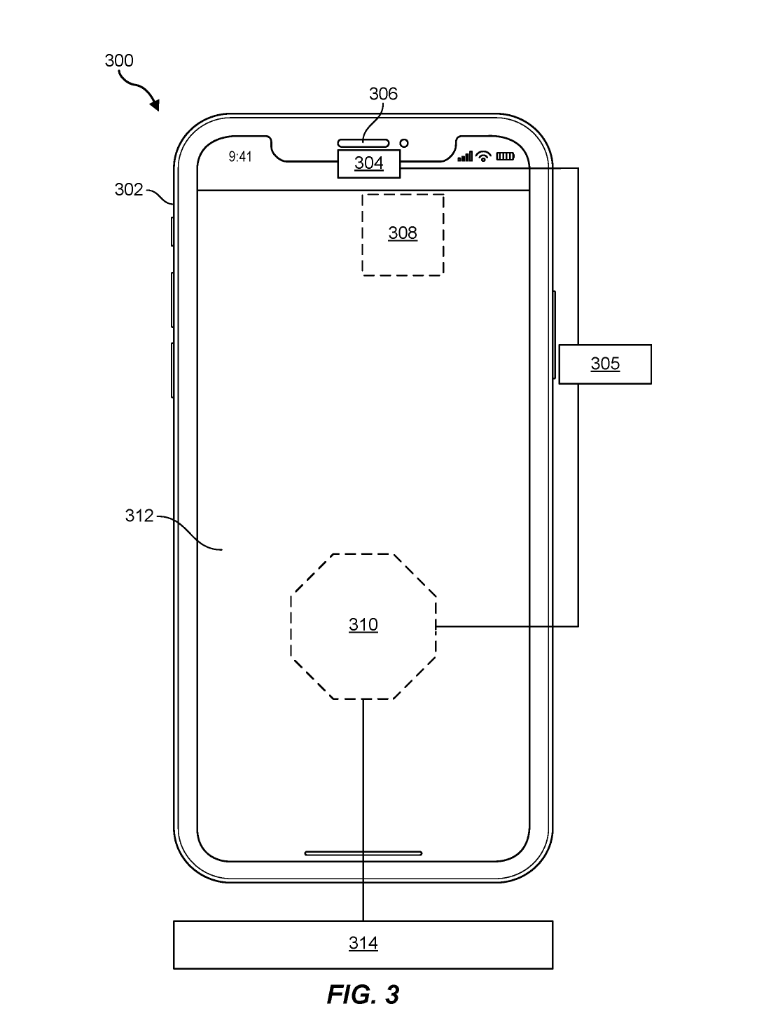

FIG. 3 is a diagram of an audio capture apparatus 300 configured to capture audio from an audio speaker 306 in a smartphone 302, according to at least one embodiment of the present disclosure.

Audio capture apparatus 300 can include a magnetic detector 304, a signal-conditioning circuit 305, and a test computer 314 to facilitate interference-resistant audio capture from electronic devices, such as smartphone 302. Magnetic detector 304 leverages electromagnetic properties of audio speaker 306 to capture audio signals from an electromagnetic coil of audio speaker 306, thereby eliminating the need for air-coupled microphones and mitigating acoustic interference and ambient noise prevalent in shared testing environments. Thus, audio capture apparatus 300 can improve audio testing when operated in conjunction with smartphone 302.

In some embodiments, smartphone 302 represents the electronic device and/or endpoint device under test and can include audio speaker 306 and display screen 312, which respectively support audio and video testing. In these embodiments, smartphone 302 can also contain other electromagnetic components 308, such as processors, power supply modules, wireless communication modules, or other speakers, that emit background electromagnetic noise. As a result, audio capture apparatus 300 can be configured to isolate magnetic field variations generated by audio speaker 306 from noise produced by other electromagnetic components 308.

During testing, magnetic detector 304 can be positioned adjacent to audio speaker 306 in various configurations. For example, magnetic detector 304 can be configured to sense variations in a magnetic field generated by an electromagnetic coil of audio speaker 306. For example, magnetic detector 304 can employ a magnetic guitar pickup adapted with custom boards and an onboard amplifier to achieve high sensitivity and directionality. As such, magnetic detector 304 may focus on a localized magnetic field of audio speaker 306 while reducing or eliminating influence from external electromagnetic interference generated by other electromagnetic components 308 or other neighboring devices. Accordingly, magnetic detector 304 can deliver signal levels for subsequent processing by signal-conditioning circuit 305.

In some embodiments, signal-conditioning circuit 305 is operatively coupled to magnetic detector 304 and processes electrical signals generated thereby. For example, signal-conditioning circuit 305 can include a pre-amplifier to adjust signal levels and/or a noise-profile module to filter background electromagnetic noise. In some embodiments, the noise-profile module can record a reference magnetic signal while audio speaker 306 is inactive, thereby capturing baseline noise from components not under test, such as other electromagnetic components 308. Subsequently, this baseline noise can be subtracted from detected variations to isolate a true audio signal from audio speaker 306. Additionally, in some examples, signal-conditioning circuit 305 can include a frequency-equalization filter to attenuate over-amplification at resonant frequencies of magnetic detector 304, thereby providing a flat frequency response across the audible spectrum.

In some embodiments, optionally, audio capture apparatus 300 can also include optical test module 310. In some embodiments, optical test module 310 can be configured to capture image data from display screen 312 of smartphone 302 and to provide that data to test computer 314 for analysis. As a result, when used in conjunction with magnetic detector 304, optical test module 310 can enable synchronization testing between visual content on display screen 312 and audio output from audio speaker 306. This can allow the system to assess whether audio-video playback delivers sufficient synchronization and quality in electronic devices.

In some embodiments, display screen 312 can present visual test media, such as flashing patterns or frame counts, to facilitate synchronization analysis with audio output from audio speaker 306. In some embodiments, optical test module 310 can capture the visual signal and test computer 314 may evaluate synchronization and quality metrics based on the captured image data.

Test computer 314 can be implemented as a central control unit for managing audio and video performance testing. In some embodiments, test computer 314 can include a processor, memory, input/output (I/O) devices, and a media test engine that collectively generate, execute, and analyze test media. For example, the processor can execute computer-readable instructions to regulate data flow between optical test module 310 and magnetic detector 304, while memory can retain the media test engine and a database containing structured test data, configurations, and results. Moreover, the media test engine can include algorithms for noise filtering, synchronization analysis, and quality assessment, thus enabling evaluation of audio and/or video outputs. Additionally, test computer 314 can support communication with endpoint devices and testing modules via interfaces such as USB, Ethernet, HDMI, and/or wireless protocols, thereby providing integration and adaptable testing across multiple devices in shared environments.

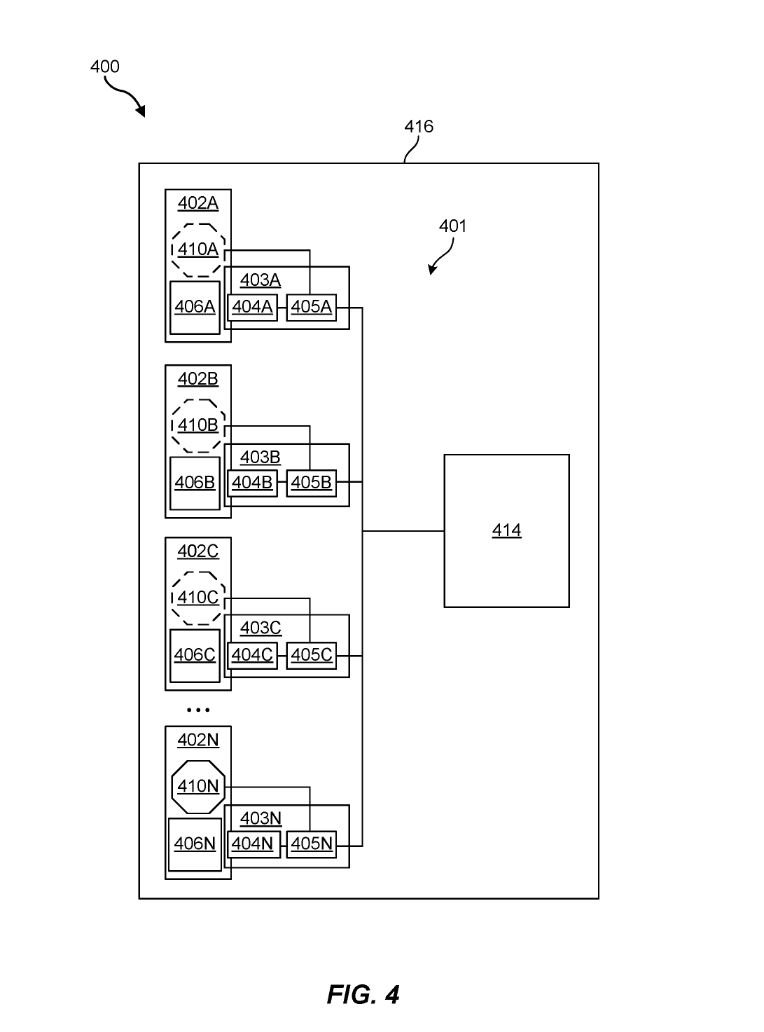

FIG. 4 is a diagram of a test environment 400 and system 401 including multiple audio capture apparatuses 403A-403N for capturing audio from multiple respective electronic devices 402A-402N, according to at least one embodiment of the present disclosure.

Test environment 400 can include a common room 416 or other space in which all the multiple electronic devices 402A-402N are located. Electronic devices 402A-402N can be considered as endpoint devices to be tested. Each of the electronic devices 402A-402N may be a respective television (e.g., a smart TV), smartphone, tablet, personal computer, digital monitor, soundbar, or the like that includes a respective audio speaker 406A-406N. In some embodiments, common room 416 can be configured to accommodate the simultaneous operation of audio capture apparatuses 403A-403N, allowing audio signals from each electronic device 402A-402N to be captured without interference from the other electronic devices 402A-402N. In this example, each electronic device 402A-402N can operate independently within the shared test environment, such that system 401 can evaluate audio performance metrics including synchronization, quality, and interference resistance.

In some examples, room 416 may lack soundproofing between the multiple electronic devices 402A-402N, since such soundproofing may be superfluous in view of the configuration of audio capture apparatuses 403A-403N, as described herein.

System 401 can include a test computer 414 operatively connected to each of audio capture apparatuses 403A-403N. In some respects, test computer 414 may be similar to any of test computers 110, 214, 314 described above. For example, test computer 414 can be configured as a central controller to manage and analyze audio and/or video performance testing of electronic devices 402A-402N. Test computer 414 can be located within room 416 as illustrated in FIG. 4, or it may be located remote from (e.g., outside of) room 416.

In some embodiments, test computer 414 can be configured to concurrently receive and record conditioned electrical audio signals from audio capture apparatuses 403A-403N on separate channels. In the example of FIG. 4, test computer 414 can further capture, prior to audio playback, for each respective electronic device 402A-402N, a reference magnetic noise profile (e.g., a baseline signal) representative of background electromagnetic noise. Thereafter, test computer 414 can subtract the reference magnetic noise profile from each subsequent conditioned electrical audio signal to provide interference-resistant audio capture without acoustic crosstalk among the plurality of electronic devices 402A-402N. Additionally, test computer 414 can support communication with audio capture apparatuses 403A-403N and other components via interfaces such as USB, Ethernet, HDMI, and/or wireless protocols, allowing for efficient integration and adaptable testing across multiple devices in the shared test environment 400.

In some embodiments, audio capture apparatuses 403A-403N can be associated with respective electronic devices 402A-402N and configured to individually capture audio signals from audio speakers 406A-406N. In these embodiments, each audio capture apparatus 403A-403N can include magnetic detector 404A-404N and signal-conditioning module 405A-405N. In the example of FIG. 4, each respective magnetic detector 404A-404N can sense variations in a magnetic field generated by the electromagnetic coil of each audio speaker 406A-406N. Magnetic detectors 404A-404N can be designed to operate concurrently within the shared test environment 400 without acoustic crosstalk. In some embodiments, multiple magnetic detectors 404A-404N can be used to respectively test audio output of two or more audio speakers of a single electronic device without unwanted crosstalk. Accordingly, the present disclosure is not limited to audio testing of multiple different electronic devices in a common space. Rather, multiple audio capture apparatuses 403A-403N and associated multiple magnetic detectors 404A-404N can be utilized in a variety of situations where multiple audio speakers 406A-406N are to be tested.

Each signal-conditioning module 405A-405N of the respective audio capture apparatuses 403A-403N can be configured to process the signals captured by magnetic detectors 404A-404N to enable high fidelity and interference resistance. Each signal-conditioning module 405A-405N can be configured to convert the sensed magnetic field variations into corresponding conditioned electrical audio signals. For example, each signal-conditioning module 405A-405N can include a pre-amplifier to adjust signal levels and a noise-profile module to filter out background electromagnetic noise (e.g., including noise from other devices, other electromagnetic components, and/or from resonance of magnetic detector 404A-404N), allowing the captured audio signals to be interference-resistant and suitable for analysis (e.g., by test computer 414).

In some embodiments, each audio speaker 406A-406N of electronic device 402A-402N can include an electromagnetic coil that generates a magnetic field in proportion to an electrical input, converting electrical signals into diaphragm vibrations and sound waves. In the example of FIG. 4, magnetic detectors 404A-404N can capture the localized magnetic field variations corresponding to the audio output of respective speakers 406A-406N.

System 401 may optionally include optical test modules 410A-410N to capture image data from respective displays of electronic devices 402A-402N. In some embodiments, when used in conjunction with magnetic detectors 404A-404N, optical test modules 410A-410N enable synchronization testing between visual content on the displays and audio output from audio speakers 406A-406N. For example, test computer 414 can assess audio-video synchronization and playback quality.

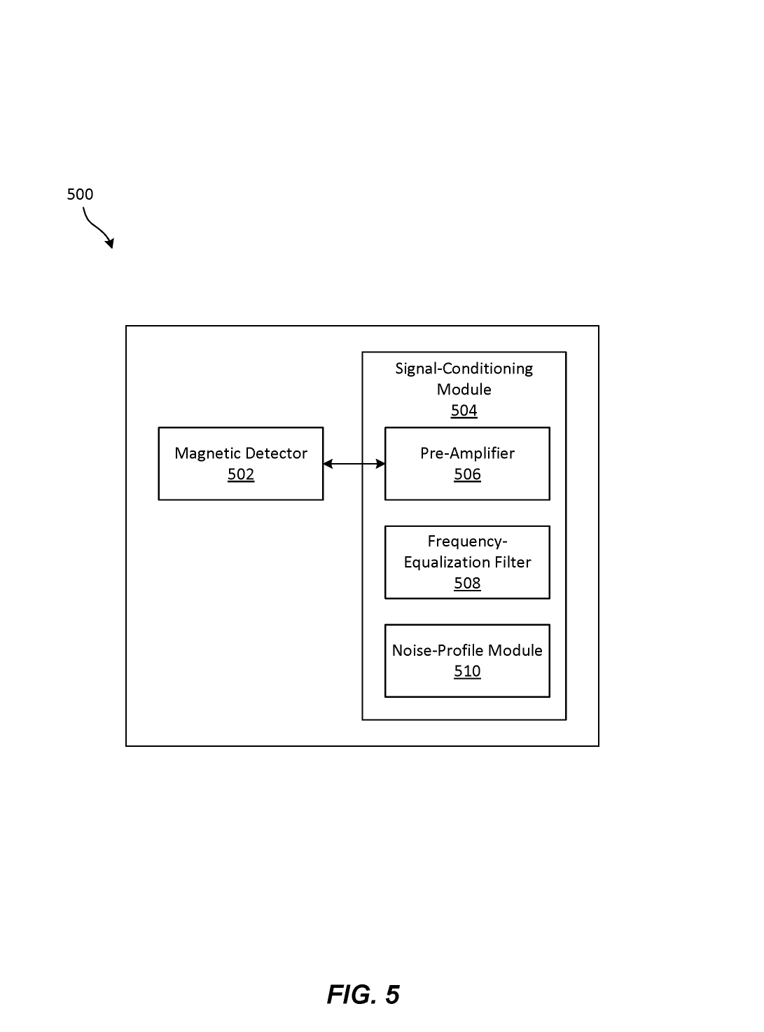

FIG. 5 is a block diagram of an audio capture apparatus 500, according to at least one embodiment of the present disclosure.

The audio capture apparatus 500 can be configured to facilitate interference-resistant audio capture from electronic devices. In some embodiments, audio capture apparatus 500 can include a magnetic detector 502 and a signal-conditioning circuit 504. Signal-conditioning circuit 504 can include one or more of a pre-amplifier 506, a frequency-equalization filter 508, and/or a noise-profile module 510. Magnetic detector 502 can sense variations in a magnetic field generated by an electromagnetic coil of an audio speaker, and signal-conditioning circuit 504 can process and condition the resulting electrical audio signals. These components may collectively enable precise, localized audio signal acquisition while reducing the potential impact of acoustic interference and ambient noise.

In some embodiments, magnetic detector 502 is configured to be positioned adjacent to an audio speaker of an electronic device. Variations in a magnetic field of the corresponding audio speaker may be directly proportional to the electrical signals driving the speaker and can correspond to the audio output. For example, the magnetic detector 502 can be implemented using a magnetic pickup microphone, such as a guitar pickup (which may be adapted with custom boards and/or an onboard amplifier), to enhance sensitivity and directionality. Accordingly, magnetic detector 502 can focus on the localized magnetic field of the audio speaker while reducing external electromagnetic interference.

In some embodiments, signal-conditioning circuit 504 can be operatively coupled to magnetic detector 502 and can be responsible for processing the electrical signals generated by the magnetic detector 502. In some embodiments, signal-conditioning circuit 504 can include multiple subcomponents, each of which may perform a specific function to ensure that the captured audio signal is interference-resistant and suitable for analysis.

In some examples, pre-amplifier 506 can be operatively coupled to magnetic detector 502 and can be configured to output an electrical audio signal corresponding to the sensed variations in the magnetic field. Pre-amplifier 506 can amplify any potentially weak electrical signals generated by magnetic detector 502 to levels appropriate for further processing. As a result, the amplified signal can preserve the original audio information while being strong enough for accurate analysis.

In some examples, frequency-equalization filter 508 is configured to attenuate over-amplification at resonant frequencies of magnetic detector 502, thereby providing a substantially flat frequency response across an audible range. As used herein, the term “flat frequency response” may generally denote a reduced or minimal deviation in gain across a target frequency band. For example, by compensating for resonant characteristics of magnetic detector 502, frequency-equalization filter 508 can ensure the captured signal accurately represents the original sound output without distortion. In some embodiments, frequency-equalization filter 508 can be implemented as a digital filter with coefficients selected in accordance with measured resonant characteristics of magnetic detector 502.

In some embodiments, noise-profile module 510 is configured to record a reference magnetic signal representative of background electromagnetic noise produced by other electromagnetic components of the electronic device and/or of neighboring devices while the audio speaker under test is not emitting. During subsequent audio capture, noise-profile module 510 can subtract the reference magnetic signal from the electrical audio signal, effectively isolating the true audio signal generated by the electromagnetic coil of the audio speaker. Thus, noise-profile module 510 can ensure interference-resistant audio capture even in environments with electromagnetic noise. Additionally, noise-profile module 510 can be designed to complete the recording of the reference magnetic signal in less than one minute, thereby enabling efficient and scalable audio testing.

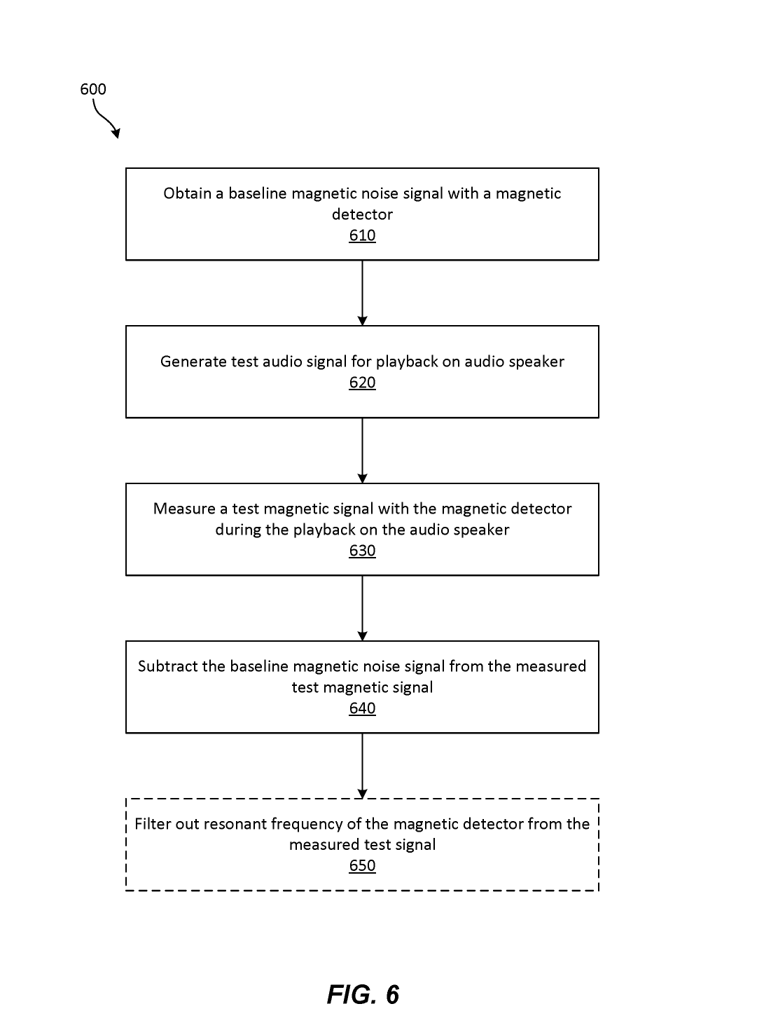

FIG. 6 is a flow diagram illustrating a method 600 for capturing an audio signal from electronic devices, according to at least one embodiment of the present disclosure.

At operation 610 of method 600, a baseline magnetic noise signal is obtained with a magnetic detector. Operation 610 may be performed in a variety of ways. For example, magnetic detector 204, 304, 404A-404N, and/or 502 may sense a baseline magnetic noise signal without a corresponding audio speaker under test being operated.

At operation 620, a test audio signal is generated for playback on the audio speaker of the electronic device. For example, this operation 620 can be performed by transmitting a predetermined audio test pattern or calibration tone to the audio speaker to produce a controlled and repeatable output suitable for measurement. The test audio signal can be selected to cover a range of frequencies or specific tones that facilitate analysis of speaker performance, dynamic range, and/or synchronization with other system components.

At operation 630, a test magnetic signal is measured with the magnetic detector during playback of the test audio signal on the audio speaker. In this operation 630, the magnetic detector, such as magnetic detector 204, 304, 404A-404N, or 502, can be positioned adjacent to the electromagnetic coil of the audio speaker under test. The magnetic detector senses variations in the magnetic field generated as the speaker reproduces the test audio signal. The resulting magnetic field variations are converted into electrical signals by the magnetic detector and forwarded to the signal-conditioning module for further processing.

At operation 640, the baseline magnetic noise signal obtained in operation 610 is subtracted from the measured test magnetic signal. This operation 640 can be performed by the noise-profile module within the signal-conditioning circuit, which digitally removes the reference magnetic signal representative of background electromagnetic noise produced by other components. By isolating the magnetic field variations attributable solely to the audio speaker, this operation ensures that the resulting audio signal is interference-resistant and accurately reflects the speaker’s output.

At operation 650, the measured test magnetic signal is further processed to filter out resonant frequencies of the magnetic detector. For example, operation 650 can be accomplished by applying a frequency-equalization filter, which attenuates over-amplification at the detector’s resonant frequencies and provides a substantially flat frequency response across the audible range. The filter can be implemented as a digital filter with coefficients selected in accordance with the measured resonant characteristics of the magnetic detector. This operation 650 can ensure that the captured audio signal is free from distortion and suitable for high-fidelity analysis in automated testing environments.

Accordingly, the present disclosure includes audio capture apparatuses, systems, and methods that may utilize a magnetic detector that may be positioned adjacent to an audio speaker of an electronic device to sense variations in a magnetic field generated by the speaker’s electromagnetic coil. The apparatus can include a signal-conditioning module with a pre-amplifier to improve signal levels and a noise-profile module that records a reference magnetic signal representing background electromagnetic noise when the speaker is inactive. During audio capture, the noise-profile module subtracts this reference signal from the detected magnetic field variations, isolating the true audio signal. This approach offers several potential benefits, including interference-resistant audio capture, elimination or reduction of a need for soundproof enclosures, and an ability to perform reliable and scalable audio testing in shared environments with multiple devices operating simultaneously. By directly measuring the magnetic properties of the speaker system and filtering out noise, the disclosed technology may ensure accurate and high-fidelity audio capture, even in noisy or electromagnetically complex environments.

The present disclosure also includes the following example embodiments.

Example 1. An audio capture apparatus, including: a magnetic detector configured to be positioned adjacent an audio speaker of an electronic device and to sense variations of a magnetic field generated by an electromagnetic coil of the audio speaker; and a signal-conditioning module including: a pre-amplifier operatively coupled to the magnetic detector and configured to output an electrical audio signal corresponding to the sensed variations; and a noise-profile module configured to: record, while the audio speaker is not emitting audio, a reference magnetic signal representative of background electromagnetic noise produced by non-speaker components of the electronic device; and during subsequent audio capture, subtract the reference magnetic signal from the electrical audio signal.

Example 2. The audio capture apparatus of Example 1, wherein the noise-profile module is configured to complete recording of the reference magnetic signal in less than one minute.

Example 3. The audio capture apparatus of Example 1 or Example 2, wherein the magnetic detector is mechanically coupled to a printed circuit board that carries the pre-amplifier.

Example 4. The audio capture apparatus of any one of Examples 1 through 3, wherein the signal-conditioning module further includes: a frequency-equalization filter configured to attenuate over-amplification at resonant frequencies of the magnetic detector to provide a substantially flat frequency response across an audible range.

Example 5. The audio capture apparatus of Example 4, wherein the frequency-equalization filter includes a digital filter having coefficients selected in accordance with measured resonant characteristics of the magnetic detector.

Example 6. The audio capture apparatus of any one of Examples 1 through 5, wherein the magnetic detector includes a magnetic pickup microphone.

Example 7. The audio capture apparatus of any one of Examples 1 through 6, wherein the signal-conditioning module further includes a user-feedback interface configured to display a real-time indication of a magnitude of the electrical audio signal to guide placement of the magnetic detector relative to the audio speaker.

Example 8. The audio capture apparatus of any one of Examples 1 through 7, wherein the magnetic detector is one of a plurality of magnetic detectors each configured to be associated with a different electronic device and to operate concurrently within a common test environment without acoustic crosstalk between the electronic devices.

Example 9. The audio capture apparatus of Example 8, wherein the plurality of magnetic detectors are coupled to a common controller configured to record audio signals from all of the plurality of magnetic detectors simultaneously on separate channels.

Example 10. A system, including: a plurality of magnetic pickup assemblies for respectively testing audio signals of a plurality of electronic devices, each magnetic pickup assembly including: a magnetic detector configured to be positioned adjacent to an audio speaker of a respective electronic device in a shared test environment to sense variations in a magnetic field generated by an electromagnetic coil of the audio speaker; and a signal-conditioning module operatively coupled to each magnetic detector and configured to convert sensed magnetic field variations into a corresponding conditioned electrical audio signal; and a controller coupled to each signal-conditioning module and configured to: concurrently receive and record the conditioned electrical audio signals from the plurality of magnetic pickup assemblies on separate channels; capture, prior to audio playback, for each respective electronic device, a reference magnetic noise profile representative of background electromagnetic noise; and subtract the reference magnetic noise profile from each subsequent conditioned electrical audio signal to provide interference-resistant audio capture without acoustic crosstalk among the plurality of electronic devices.

Example 11. The system of Example 10, wherein the controller is configured to complete capture of the reference magnetic noise profile for each respective electronic device in less than one minute.

Example 12. The system of Example 10 or Example 11, wherein each signal-conditioning module includes a pre-amplifier operatively coupled to the magnetic detector.

Example 13. The system of any one of Examples 10 through 12, wherein each signal-conditioning module further includes a frequency-equalization filter configured to attenuate over-amplification at resonant frequencies of the magnetic detector.

Example 14. The system of any one of Examples 10 through 13, wherein each magnetic detector includes a magnetic pickup microphone.

Example 15. The system of any one of Examples 10 through 14, wherein each electronic device of the plurality of electronic devices is selected from the group consisting of: smartphones; digital televisions; computer monitors; tablets; and soundbars.

Example 16. A method for capturing an audio signal, including: obtaining a baseline magnetic noise signal with a magnetic detector; generating a test audio signal for playback on an audio speaker of an electronic device; measuring a test magnetic signal with the magnetic detector during the playback on the audio speaker, wherein the magnetic detector senses variations of a magnetic field generated by an electromagnetic coil of the audio speaker; and subtracting the baseline magnetic noise signal from the measured test magnetic signal to obtain a filtered test audio signal.

Example 17. The method of Example 16, further including filtering out a resonant frequency of the magnetic detector from the measured test magnetic signal to obtain the filtered test audio signal.

Example 18. The method of Example 16 or Example 17, wherein obtaining the baseline magnetic noise signal includes recording the baseline magnetic noise signal for a duration of less than one minute while the audio speaker is not emitting audio.

Example 19. The method of any one of Examples 16 through 18, further including: identifying a resonant frequency of the magnetic detector; and attenuating over-amplification of the measured test magnetic signal at the resonant frequency of the magnetic detector.

Example 20. The method of any one of Examples 16 through 19, further including displaying, via a user-feedback interface, a real-time indication of a magnitude of the measured test magnetic signal to guide placement of the magnetic detector relative to the audio speaker.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In some embodiments, one or more of the modules described herein may be implemented as a circuit. For example, the signal-conditioning module may include a printed circuit board (PCB) that integrates the pre-amplifier, frequency-equalization filter, and/or noise-profile module as discrete or integrated electronic components. The pre-amplifier circuit may include operational amplifiers and associated passive elements configured to boost the electrical signal generated by the magnetic detector to a suitable level for further processing. The frequency-equalization filter may be realized as an analog or digital filter circuit, with selectable and/or programmable coefficients to attenuate resonant frequencies and achieve a flat frequency response across the audible spectrum. The noise-profile module may incorporate analog-to-digital converters, memory elements, and/or digital signal processing logic to record, store, and subtract reference magnetic noise signals from the captured audio signal in real time. These circuits may be arranged on a common PCB to minimize signal path length and electromagnetic interference and may be powered by an onboard and/or external power supply. By implementing any of these modules as a circuit, the audio capture apparatus achieves compactness, reliability, and efficient integration with electronic devices under test.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An audio capture apparatus, comprising:
a magnetic detector configured to be positioned adjacent an audio speaker of an electronic device and to sense variations of a magnetic field generated by an electromagnetic coil of the audio speaker; and
a signal-conditioning module including:
a pre-amplifier operatively coupled to the magnetic detector and configured to output an electrical audio signal corresponding to the sensed variations; and
a noise-profile module configured to:
record, while the audio speaker is not emitting audio, a reference magnetic signal representative of background electromagnetic noise produced by non-speaker components of the electronic device; and
during subsequent audio capture, subtract the reference magnetic signal from the electrical audio signal to obtain a filtered test audio signal.

2. The audio capture apparatus of claim 1, wherein the noise-profile module is configured to complete recording of the reference magnetic signal in less than one minute.

3. The audio capture apparatus of claim 1, wherein the magnetic detector is mechanically coupled to a printed circuit board that carries the pre-amplifier.

4. The audio capture apparatus of claim 1, wherein the signal-conditioning module further comprises:
a frequency-equalization filter configured to attenuate over-amplification at resonant frequencies of the magnetic detector to provide a substantially flat frequency response across an audible range.

5. The audio capture apparatus of claim 4, wherein the frequency-equalization filter comprises a digital filter having coefficients selected in accordance with measured resonant characteristics of the magnetic detector.

6. The audio capture apparatus of claim 1, wherein the magnetic detector comprises a magnetic pickup microphone.

7. The audio capture apparatus of claim 1, wherein the signal-conditioning module further comprises a user-feedback interface configured to display a real-time indication of a magnitude of the electrical audio signal to guide placement of the magnetic detector relative to the audio speaker.

8. The audio capture apparatus of claim 1, wherein the magnetic detector is one of a plurality of magnetic detectors each configured to be associated with a different electronic device and to operate concurrently within a common test environment without acoustic crosstalk between the electronic devices.

9. The audio capture apparatus of claim 8, wherein the plurality of magnetic detectors are coupled to a common controller configured to record audio signals from all of the plurality of magnetic detectors simultaneously on separate channels.

10. A system, comprising:
a plurality of magnetic pickup assemblies for respectively testing audio signals of a plurality of electronic devices, each magnetic pickup assembly comprising:
a magnetic detector configured to be positioned adjacent to an audio speaker of a respective electronic device in a shared test environment to sense variations in a magnetic field generated by an electromagnetic coil of the audio speaker; and
a signal-conditioning module operatively coupled to each magnetic detector and configured to convert sensed magnetic field variations into a corresponding conditioned electrical audio signal; and
a controller coupled to each signal-conditioning module and configured to:
concurrently receive and record the conditioned electrical audio signals from the plurality of magnetic pickup assemblies on separate channels;
capture, prior to audio playback, for each respective electronic device, a reference magnetic noise profile representative of background electromagnetic noise; and
subtract the reference magnetic noise profile from each subsequent conditioned electrical audio signal to provide interference-resistant audio capture without acoustic crosstalk among the plurality of electronic devices.

11. The system of claim 10, wherein the controller is configured to complete capture of the reference magnetic noise profile for each respective electronic device in less than one minute.

12. The system of claim 10, wherein each signal-conditioning module comprises a pre-amplifier operatively coupled to the magnetic detector.

13. The system of claim 10, wherein each signal-conditioning module further comprises a frequency-equalization filter configured to attenuate over-amplification at resonant frequencies of the magnetic detector.

14. The system of claim 10, wherein each magnetic detector comprises a magnetic pickup microphone.

15. The system of claim 10, wherein each electronic device of the plurality of electronic devices is selected from the group consisting of:
smartphones;
digital televisions;
computer monitors;
tablets; and
soundbars.

16. A method for capturing an audio signal, comprising:
obtaining a baseline magnetic noise signal with a magnetic detector;
generating a test audio signal for playback on an audio speaker of an electronic device;
measuring a test magnetic signal with the magnetic detector during the playback on the audio speaker, wherein the magnetic detector senses variations of a magnetic field generated by an electromagnetic coil of the audio speaker; and
subtracting the baseline magnetic noise signal from the measured test magnetic signal to obtain a filtered test audio signal.

17. The method of claim 16, further comprising filtering out a resonant frequency of the magnetic detector from the measured test magnetic signal to obtain the filtered test audio signal.

18. The method of claim 16, wherein obtaining the baseline magnetic noise signal comprises recording the baseline magnetic noise signal for a duration of less than one minute while the audio speaker is not emitting audio.

19. The method of claim 16, further comprising:
identifying a resonant frequency of the magnetic detector; and
attenuating over-amplification of the measured test magnetic signal at the resonant frequency of the magnetic detector.

20. The method of claim 16, further comprising displaying, via a user-feedback interface, a real-time indication of a magnitude of the measured test magnetic signal to guide placement of the magnetic detector relative to the audio speaker.
